(19) United States
(12) Patent Application Publication
(10) Pub. No.: US 2012/0140277 A1
(43) Pub. Date: Jun. 7, 2012

(54) IMAGE FORMING APPARATUS AND PROCESSING CONTROL METHOD

(75) Inventor: Fumiyuki Watanabe, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/310,887

(22) Filed: Dec. 5, 2011

Related U.S. Application Data
(60) Provisional application No. 61/420,558, filed on Dec. 7, 2010.

(51) Int. Cl. G06F 3/12

(52) U.S. Cl. 358/1.15

(57) ABSTRACT

According to one embodiment, an image forming apparatus includes: a user interface configured to display, if an external storage is connected to the image forming apparatus, as a list, file information for specifying data files stored in the external storage and display a screen including printing options for all data files selected by a user; and a determining section configured to determine whether a designated printing option is effective with respect to the selected data files.

### CROSS-REFERENCE TO RELATED APPLICATION

This application is based upon and claims the benefit of priority from: U.S. provisional application 61/420558, filed on Dec. 7, 2010; the entire contents all of which are incorporated herein by reference.

### FIELD

Embodiments described herein relate generally to an image forming apparatus connectable to an external storage.

### BACKGROUND

There is known an image forming apparatus including an I/F (Interface) that connects an external storage such as a USB memory (USB: Universal Serial Bus) and having a function of printing data stored in the external storage.

The image forming apparatus displays, on a display section, data files stored in, for example, the USB memory connected to the I/F.

A user selects one data file, which the user desires to print, from the data files displayed on the display section and designates, in an operation section of the image forming apparatus, for example, a sheet size, two-sided printing, and stapling as printing options.

The image forming apparatus applies printing to the selected data file according to the set printing options.

If plural data files among the data files stored in the USB memory are printed, the user performs the selection of a data file and the setting of printing options every time the printing for one data file ends.

### DESCRIPTION OF THE DRAWINGS

FIG. 1 is a schematic diagram of an image forming apparatus according to an embodiment;

FIG. 2 is a diagram of a hardware configuration of the image forming apparatus;

FIG. 3 is a diagram of functional blocks of the image forming apparatus;

FIG. 4 is a diagram of a display example of an initial screen in the embodiment;

FIG. 5 is a diagram of a display example of a ready screen in a print mode in the embodiment;

FIG. 6 is a diagram of a display example of a printing option setting screen in the embodiment;

FIG. 7 is a diagram of a display example of a sheet size setting screen in the embodiment;

FIG. 8 is a diagram of a display example of a finishing condition setting screen in the embodiment;

FIG. 9 is a diagram of a display example of a one-sided or two-sided printing condition setting screen in the embodiment;

FIG. 10 is a diagram of a display example of a monochrome or color printing condition setting screen of a UI section in the embodiment;

FIG. 11A is a first flowchart for explaining processing in the embodiment;

FIG. 11B is a second flowchart for explaining the processing; and

FIG. 11C is a third flowchart for explaining the processing.

### DETAILED DESCRIPTION

In general, according to one embodiment, an image forming apparatus includes a detecting section, a determining section, a UI section (UI: User Interface), a starting section, and a processing executing section.

The detecting section detects connection of an external storage.

The UI section displays a screen including a list of file information (e.g., file names) for specifying data files stored in the external storage and causes a user to select data files to be printed. Further, the UI section displays a screen including plural printing options and causes the user to select printing options common to the selected data files.

The determining section determines, from attribute information (e.g., the number of pages) included in the data files selected in the UI section, whether the printing options selected in the UI section are effective.

The starting section starts a hardware unit necessary for printing on the basis of image data corresponding to the selected data files.

On the basis of a determination result of the determining section, the processing executing section releases ineffective printing options and performs, according to effective printing options, printing to correspond to the data files using the hardware unit started by the starting section.

An embodiment is explained below with reference to the accompanying drawings.

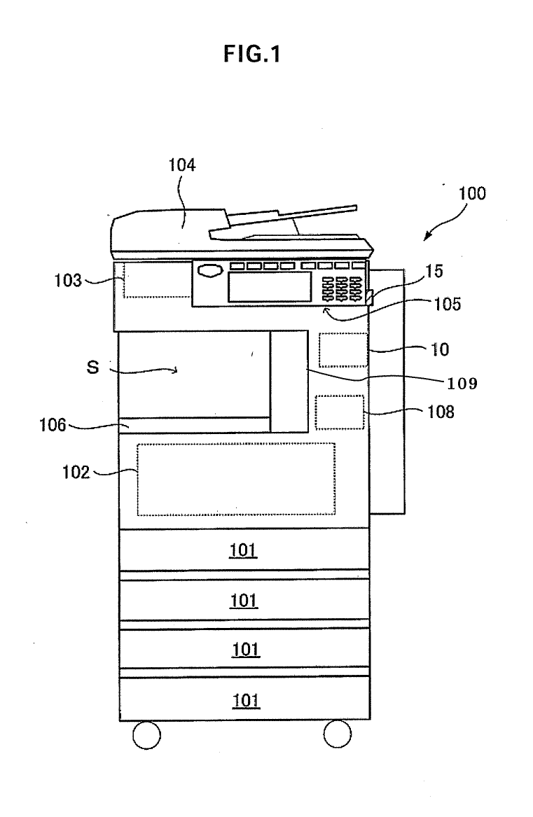

An image forming apparatus (MFP: Multi Function Peripheral) is explained with reference to FIG. 1. FIG. 1 is a schematic front view of the image forming apparatus.

An image forming apparatus 100 includes plural paper feeding cassettes 101. Each of the paper feeding cassettes 101 stores plural sheets. The plural sheets stored in the paper feeding cassette 101 are fed to a printer section 102 through a sheet conveying path. The printer section 102 forms a visible image on a sheet on the basis of image data. The image data includes, besides image data corresponding to data files stored in an external storage (e.g., a USB memory 60), for example, image data transmitted from an external apparatus (e.g., a personal computer) to the image forming apparatus 100 and image data generated according to reading operation of a scanner section 103.

The scanner section 103 scans images of a sheet document and a book document to thereby generate image data. An apparatus (ADF: Auto Document Feeder) 104 for automatically conveying an original document to the scanner section 103 is provided above the scanner section 103.

A control panel 105 for inputting various kinds of information to the image forming apparatus 100 is provided in an upper part of the image forming apparatus 100. The control panel 105 can include, for example, button switches and a touch panel.

The printer section 102 can form a visible image corresponding to image data on the sheet according to a known recording system such as an electrophotographic system or an inkjet system.

The sheet having the visible image formed thereon passes through the sheet conveying path and moves to a paper discharge space S through a finishing section 109.

The finishing section 109 applies stapling to the sheet having the visible image formed thereon. The stapling is executed according to a condition when finishing is selected as a printing option on the control panel 105.

A paper discharge tray 106 for stacking sheets is provided in the paper discharge space S.

The image forming apparatus 100 includes a power supply section 108 and a system section 10.

In the configuration shown in FIG. 1, the scanner section 103 is provided in the image forming apparatus 100 functioning as a digital multi function peripheral. However, this embodiment is not limited to the configuration. This embodiment can also be applied when a stand-alone scanner is connected to the image forming apparatus 100 functioning as the digital multi function peripheral and when only the image forming apparatus 100 configures a product. The finishing section 109 is provided in the image forming apparatus 100. However, this embodiment can also be applied when a stand-alone finishing apparatus is connected to the image forming apparatus 100.

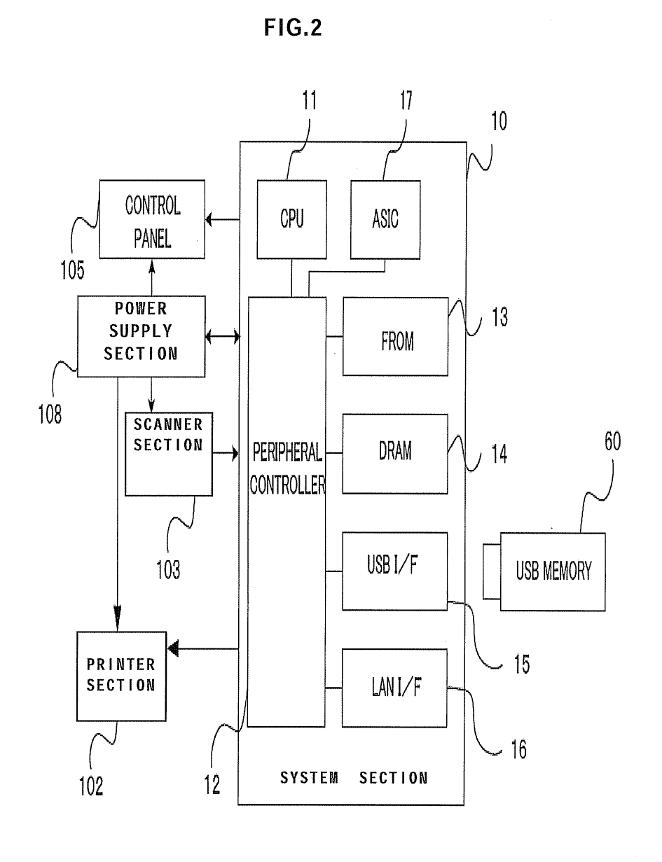

A hardware configuration (mainly the configuration of the inside of the system section 10) necessary for carrying out this embodiment in the image forming apparatus 100 is shown in FIG. 2.

A computer program for causing the image forming apparatus 100 to operate is stored in an FROM 13 (FROM: Flash Read Only Memory). A CPU 11 (CPU: Central Processing Unit) decodes and executes the computer program to control the image forming apparatus 100.

An arithmetic operation in executing the computer program is performed using a DRAM 14 (DRAM: Dynamic Random Access Memory).

An ASIC (Application Specific Integrated Circuit) 17 is a processing circuit that can execute processing determined in advance. The ASIC 17 executes various kinds of processing in the image forming apparatus 100.

Control of the control panel 105 and various I/O ports such as a USB I/F 15 (I/F: Interface) and a LAN I/F 16 (LAN: Local Area Network) is executed by a peripheral controller 12.

Power supply to I/Fs in the scanner section 103, the finishing section 109, the printer section 102, the control panel 105, and the system section 10 is performed by the power supply section 108. The CPU 11 performs control of the power supply.

The USB memory 60 is used when read data is stored during scanning and when stored image data is printed. The USB memory 60 is connected to the image forming apparatus 100 via the USB I/F 15.

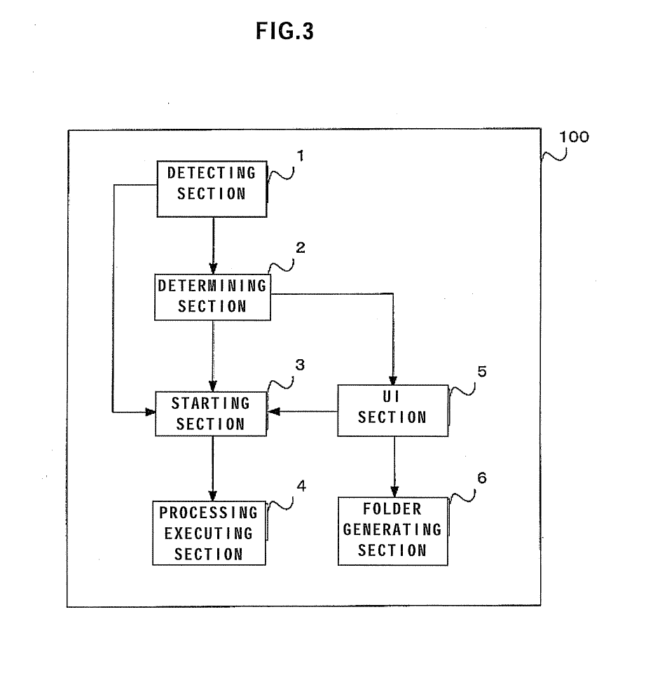

An example of functional blocks in this embodiment is shown in FIG. 3. The image forming apparatus 100 includes a detecting section 1, a determining section 2, a starting section 3, a processing executing section 4, and a UI section (UI: User Interface). Operation contents of these functional blocks are explained later with reference to flowcharts.

Correspondence between the functional blocks shown in FIG. 3 and the hardware configuration shown in FIG. 2 is explained.

The detecting section 1 is realized by the CPU 11, the peripheral controller 12, the USE I/F 15, a USB related driver (program) in the FROM 13, and the DRAM 14 cooperating with one another.

The determining section 2 is realized by the CPU 11, the USB I/F 15, the peripheral controller 12, the DRAM 14, and a determination program in the FROM 13 cooperating with one another.

The starting section 3 is realized by the CPU 11, the power supply section 108, the DRAM 14, a driver or a power supply control program in the FROM 13 for controlling the power supply section 108, and the peripheral controller 12 cooperating with one another.

The processing executing section 4 is realized by the CPU 11, the scanner section 103, the printer section 102, the DRAM 14, the USB I/F 15, the LAN I/F 16, and a driver in the FROM 13 for controlling these kinds of hardware cooperating with one another.

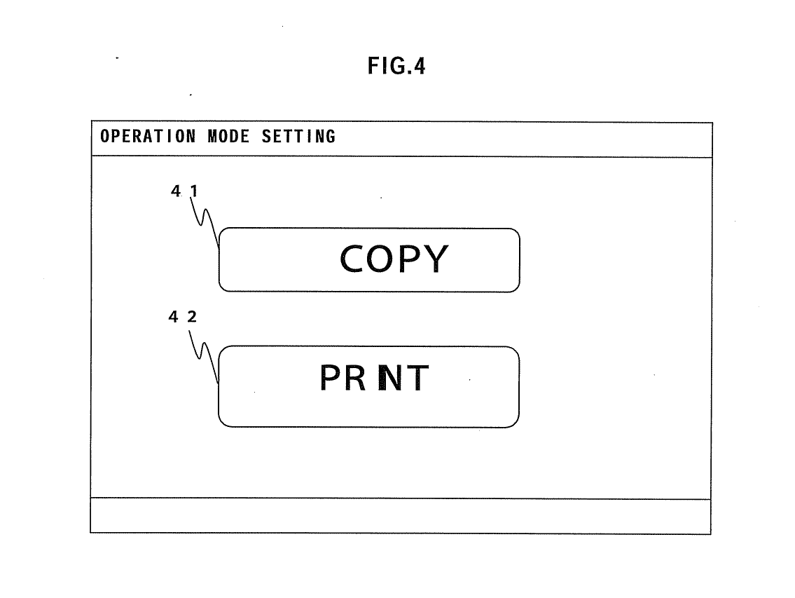

The UI section 5 is realized by the CPU 11, the DRAM 14, the control panel 105, the USB I/F 15, the peripheral controller 12, and a driver in the FROM 13 for controlling these kinds of hardware cooperating with one another. Examples of screens displayed on the touch panel of the control panel 105 by the UI section 5 are shown in FIGS. 4 to 10.

A display screen shown in FIG. 4 is an initial screen. On the initial screen, for example, a copy icon 41 for selecting a copy mode and a print icon 42 for selecting a print mode are displayed.

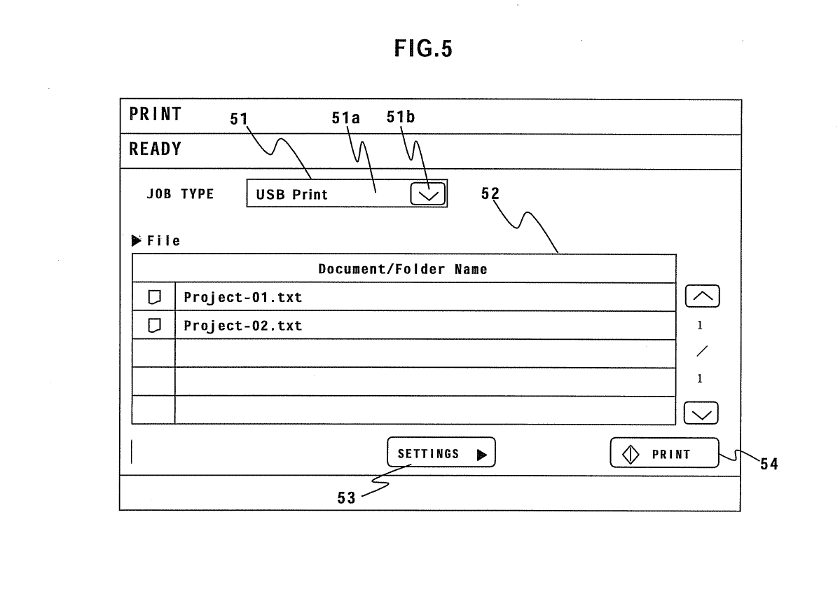

A display screen shown in FIG. 5 is a ready screen displayed if the print mode is selected in the initial screen. The ready screen is displayed if the image forming apparatus 100 is in a ready state (e.g., a state in which printing by the printer section 102 is possible).

On the ready screen shown in FIG. 5, for example, a job type display and selecting section 51, a file display section 52, a setting button 53, and a print button 54 are displayed. The job type display and selecting section 51 includes an area 51a in which a currently-selected job type is displayed and a job type selection button 51b.

The job type display area 51a of the ready screen shown in FIG. 5 is in a display state in which USB print is selected as a job type.

The job type selection button 51b is a button for selecting a job type. If a user presses the job type selection button 51b, a menu of plural job types such as USB print (for printing data stored in a USB), private print (printing requiring personal authentication), normal print (printing not requiring personal authentication), and trial print (printing of, for example, only one page for trial) is displayed. The user can select a desired job type such as the USB print out of the menu. If the USB memory 60 is not connected to the image forming apparatus 100, for example, the USB print is not displayed in the menu.

If the USB print is selected as the job type, the file display section 52 displays a list of file information (e.g., file names) for specifying data files that are stored in the USB memory 60 connected to the image forming apparatus and can be printed. The file display section 52 shown in FIG. 5 is in a state in which, for example, “Project-01” and “Project-02” of a folder 1 are displayed as file names. The list of the file display section 52 is a list for the user to select a data file that the user desires to print. In the list, the user can select the data file, which the user desires to print, by touching a position where the file name is displayed. If the user touches plural positions where file names are displayed, the user can simultaneously select plural data files that the user desires to print. In the list, for example, a display color of a selected file name changes if the user touches the selected file name. Since the display color changes, a selected document file and an unselected document file are displayed to be distinguished from each other. If the user touches the already-selected file name (a position where the file name is displayed), the display color of which changes, again, the display color returns to the original display color and the selected state is released. In the example explained above, the file names are displayed as the file information for specifying data files. However, the file information is not limited to the file names and may be, for example, file creators or file creation dates or may be a combination of the file creators and the file creation dates.

The setting button 53 is a button for switching a display screen to a setting screen for setting printing options (e.g., a sheet size, finishing, one-sided or two-sided printing, and monochrome or color printing) in printing a data file, a file name of which is selected.

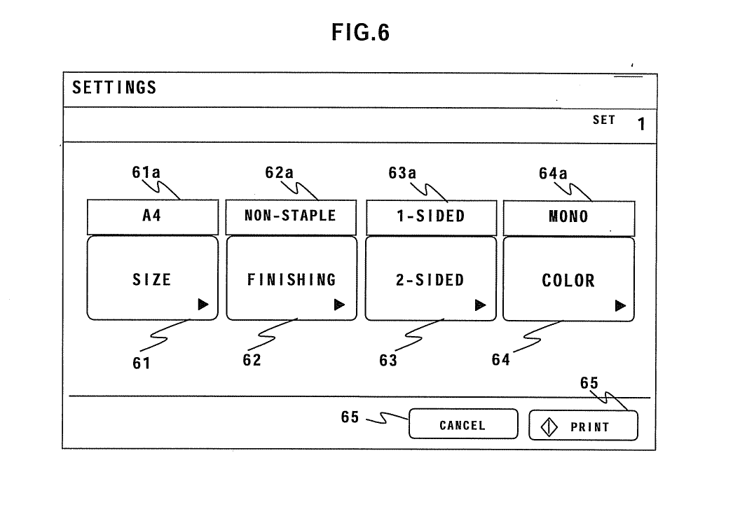

On the display screen shown in FIG. 5, if the user presses the setting button 53, the touch panel of the control panel 105 displays a printing option setting screen shown in FIG. 6. Printing options to be set are printing options commonly set for the selected plural document files. Therefore, if the plural data files are selected, it is unnecessary to perform setting of the printing options for each data file. If the user desires to set the printing options for each data file, it is also possible to set the printing options for each data file by repeating a step of selecting one document file in the selection of a data file, setting the printing options, and pressing the print button 54 to print the document file.

The print button 54 is a button for instructing the start of printing. If the printing start is instructed by the print button 54, the image forming apparatus 100 prints the selected data files according to the currently-set printing options. As explained above, the printing options are commonly set for the selected data files. Therefore, if two document files are selected and the sheet size A4 is set as a printing option, both the two document files are printed on an A4 size sheet.

The display screen shown in FIG. 6 is a screen for setting the printing options. As explained above, if the setting button 53 is operated on the ready screen shown in FIG. 5, the touch panel of the control panel 105 displays this setting screen. On the setting screen, for example, icons 61, 62, 63, and 64 of the plural printing options, setting-state display sections 61a, 62a, 63a, and 64a corresponding to the icons of the printing options, a cancel button 65, and a print button 66 are displayed.

The icons 61, 62, 63, and 64 of the printing options are icons for displaying setting screens for setting conditions in the printing options. In the setting screen shown in FIG. 6, as the icons of the printing options, a sheet size setting icon 61, a finishing setting icon 62, a one-sided or two-sided printing setting icon 63, and a monochrome or color printing setting icon 64 are displayed. If the sheet size setting icon 61 is operated, the touch panel of the control panel 105 displays a screen for specifically setting a sheet size. If the finishing setting icon 62 is operated, the touch panel of the control panel 105 displays a screen for specifically setting a condition for finishing. If the one-sided or two-sided printing setting icon 63 is operated, the touch panel of the control panel 105 displays a screen for specifically setting a condition for one-sided or two-sided printing. If the monochrome or color mode printing setting icon 64 is operated, the touch panel of the control panel 105 displays a screen for specifically setting a condition for monochrome or color printing.

The setting-state display sections 61a, 62a, 63a, and 64a are display sections configured to display setting states of the printing options. On the option setting screen shown in FIG. 6, it is displayed in the setting-state display sections 61a, 62a, 63a, and 64a that A4 is set as the sheet size, a non-staple mode is set as the finishing, one-sided printing is set as the one-sided or two-sided printing, and monochrome printing is set as the monochrome or color printing.

The cancel button 65 is a button for cancelling setting by the printing option setting screen. On the printing option setting screen shown in FIG. 6, if the cancel button 65 is operated, for example, the printing option setting screen returns to the previous screen (the ready screen shown in FIG. 5).

The print button 66 is a button for instructing the start of printing. On the setting screen shown in FIG. 6, if the print button 66 is operated, the selected data files are printed according to setting states of the printing options displayed in the setting-state display sections 61a, 62a, 63a, and 64a.

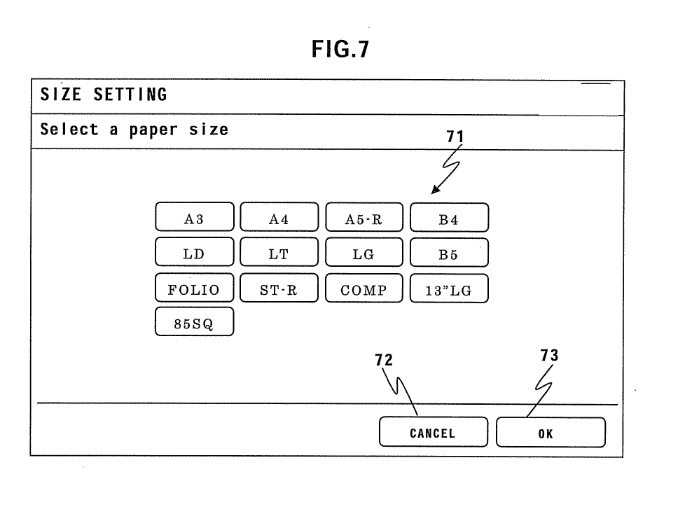

A display screen shown in FIG. 7 is a size setting screen for specifically setting a sheet size if the sheet size setting icon 61 is set as the printing option. On the size setting screen, size icons 71 corresponding to various sizes, a cancel button 72, and an OK button 73 are displayed. A guide for urging paper size setting is displayed above the setting screen.

In the size icons 71, sizes corresponding thereto are displayed. If the size icon 71 is operated by the user, a size displayed in the icon is set as a sheet size. For example, a display color of the operated size icon (the set size) changes. The size icon is displayed to be distinguished from the size icons not set. In a default state, the A4 size is set and a display color of the size icon in which A4 is displayed changes.

The cancel button 72 is a button for cancelling a sheet size set anew on the size setting screen shown in FIG. 7 and returning to, for example, the immediately preceding screen. If the cancel button 72 is operated, a sheet size set anew on the size setting screen shown in FIG. 7 is cancelled and the size setting screen returns to the setting screen shown in FIG. 6. At this point, on the setting screen shown in FIG. 6, a sheet size set before the size setting screen shown in FIG. 7 is displayed is displayed in the setting-state display section 61a.

The OK button 73 is a button for deciding a sheet size set anew on the size setting screen shown in FIG. 7. If the OK button 73 is operated, setting of a set sheet size is decided and the size setting screen returns to the setting screen shown in FIG. 6. At this point, on the setting screen shown in FIG. 6, the sheet size set anew is displayed in the setting-state display section 61a.

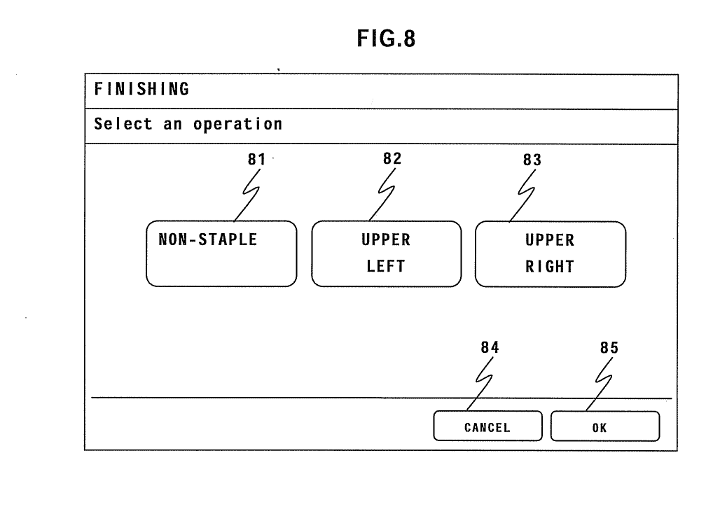

A display screen shown in FIG. 8 is a condition setting screen for setting specific conditions (whether stapling is performed and a position where the stapling is performed) if the finishing is set as the printing option. On this finishing condition setting screen, as conditions for the finishing, for example, a non-staple icon 81, an upper left stapling icon 82, and an upper right stapling icon 83 are displayed.

If each of the finishing condition icons 81, 82, and 83 is operated by the user and a desired condition icon is set, for example, a display color of the finishing condition icon changes. Since the display color changes, in the finishing condition icons, the currently-set finishing condition icon and the finishing condition icons not set are displayed to be distinguished from each other.

The non-staple icon 81 is a condition setting icon for setting that the finishing section 109 does not perform the stapling with staples.

The upper left stapling icon 82 is a condition setting icon for setting that the upper left of sheets is stapled with staples.

The upper right stapling icon 83 is a condition setting icon for setting that the upper right of sheets is stapled with staples.

In the default state, non-staple is set and a display color of the non-staple icon 81 changes.

Besides, on the finishing condition setting screen, a cancel button 84 and an OK button 85 are displayed.

The cancel button 84 is a button for cancelling a condition set anew on the finishing condition setting screen shown in FIG. 8 and returning to, for example, the immediately preceding screen. If the cancel button 84 is operated, a condition set anew on the finishing condition setting screen shown in FIG. 8 is cancelled and the finishing condition setting screen returns to the printing option setting screen shown in FIG. 6. At this point, on the printing option setting screen shown in FIG. 6, a condition (in FIG. 6, the non-staple) set before the finishing condition setting screen shown in FIG. 8 is displayed is displayed in the setting-state display section 62a.

The OK button 85 is a button for deciding a condition set anew on the finishing condition setting screen shown in FIG. 8. If the OK button 85 is operated, setting of a set processing condition is decided and the finishing condition setting screen returns to the printing option setting screen shown in FIG. 6. At this point, on the printing option setting screen shown in FIG. 6, a condition (in FIG. 6, the non-staple) set anew is displayed in the setting-state display section 62a.

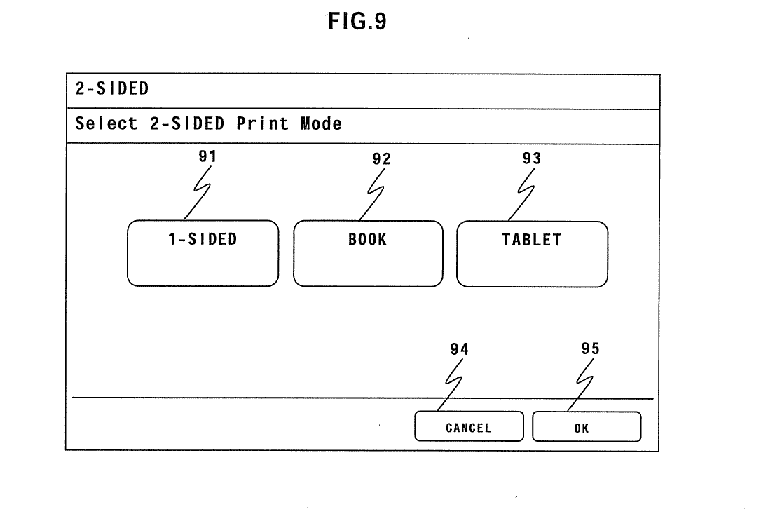

A display screen shown in FIG. 9 is a one-sided or two-sided printing condition setting screen for setting a printing condition if the one-sided or two-sided printing is set as the printing option. On the one-sided or two-sided printing condition setting screen, a one-sided printing icon 91, a book printing icon 92, and a tablet printing icon 93 are displayed as printing conditions.

If each of the printing condition icons 91, 92, and 93 is operated by the user and a desired printing condition icon is set, for example, a display color of the printing condition icon changes. Since the display color changes, in the printing condition icons, the currently-set icon and the icons not set are displayed to be distinguished from each other.

The one-sided printing icon 91 is an icon for setting the one-sided printing for printing on one side of a sheet.

The book printing icon 92 is an icon for setting the two-sided printing for printing on both sides of a sheet in a book form.

The tablet printing icon 93 is an icon for setting the two-sided printing for printing on both sides of a sheet in a tablet form.

In the default state, the one-sided printing is set and a display color of the one-sided printing icon 91 changes.

Besides, on the one-sided or two-sided printing condition setting screen, a cancel button 94 and an OK button 95 are displayed.

The cancel button 94 is a button for cancelling a printing condition set anew on the one-sided or two-sided printing condition setting screen shown in FIG. 9 and returning to, for example, the immediately preceding screen. If the cancel button 93 is operated, a printing condition set anew on the one-sided or two-sided printing condition setting screen shown in FIG. 9 is cancelled and the one-sided or two-sided printing condition setting screen returns to the setting screen shown in FIG. 6. At this point, on the setting screen shown in FIG. 6, a printing condition (in FIG. 6, the one-sided printing) set before the one-sided or two-sided printing condition setting screen shown in FIG. 9 is displayed is displayed in the setting-state display section 63a.

The OK button 95 is a button for deciding a printing condition set anew on the one-sided or two-sided printing condition setting screen shown in FIG. 9. If the OK button 95 is operated, setting of a set printing condition is decided and the one-sided or two-sided printing condition setting screen returns to the setting screen shown in FIG. 6. At this point, on the setting screen shown in FIG. 6, a printing condition (in FIG. 6, the one-sided printing) set anew is displayed in the setting-state display section 63a.

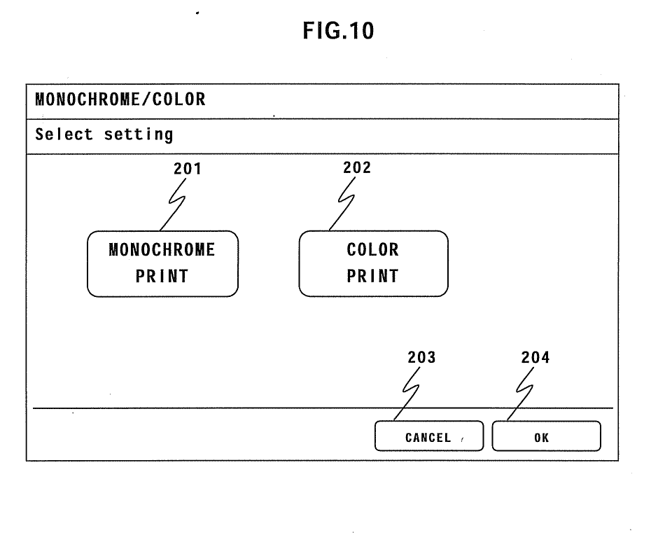

A display screen shown in FIG. 10 is a condition setting screen for setting a printing condition if the monochrome or color printing is set as the printing option. On the monochrome or color printing condition setting screen, a monochrome printing icon 201 and a color printing icon 202 are displayed as condition setting icons. If each of the condition setting icons 201 and 202 is operated by the user and a desired condition icon is set, for example, a display color of the condition icon changes. Since the display color changes, in the setting icons, the currently-set icon and the icon not set are displayed to be distinguished from each other.

The monochrome printing icon 201 is an icon for setting that printing is performed in monochrome.

The color printing icon 202 is an icon for setting that printing is performed in color. In the default state, the monochrome printing is set and a display color of the condition setting icon changes.

A cancel button 203 is a button for cancelling a printing condition set anew on the monochrome or color printing condition setting screen shown in FIG. 10 and returning to, for example, the immediately preceding screen. If the cancel button 203 is operated, a printing condition set anew on the monochrome or color printing condition setting screen shown in FIG. 10 is cancelled and the monochrome or color printing condition setting screen returns to the printing option setting screen shown in FIG. 6. At this point, on the printing option setting screen shown in FIG. 6, a printing condition (in FIG. 6, the monochrome printing) already set before the monochrome or color printing condition setting screen shown in FIG. 10 is displayed is displayed in the setting-state display section 64a.

An OK button 204 is a button for deciding a printing condition set anew on the monochrome or color printing condition setting screen shown in FIG. 10. If the OK button 204 is operated, setting of a printing condition is decided and the monochrome or color printing condition setting screen returns to the printing option setting screen shown in FIG. 6. At this point, on the printing option setting screen shown in FIG. 6, a printing condition (in FIG. 6, the monochrome printing) set anew is displayed in the setting-state display section 64a.

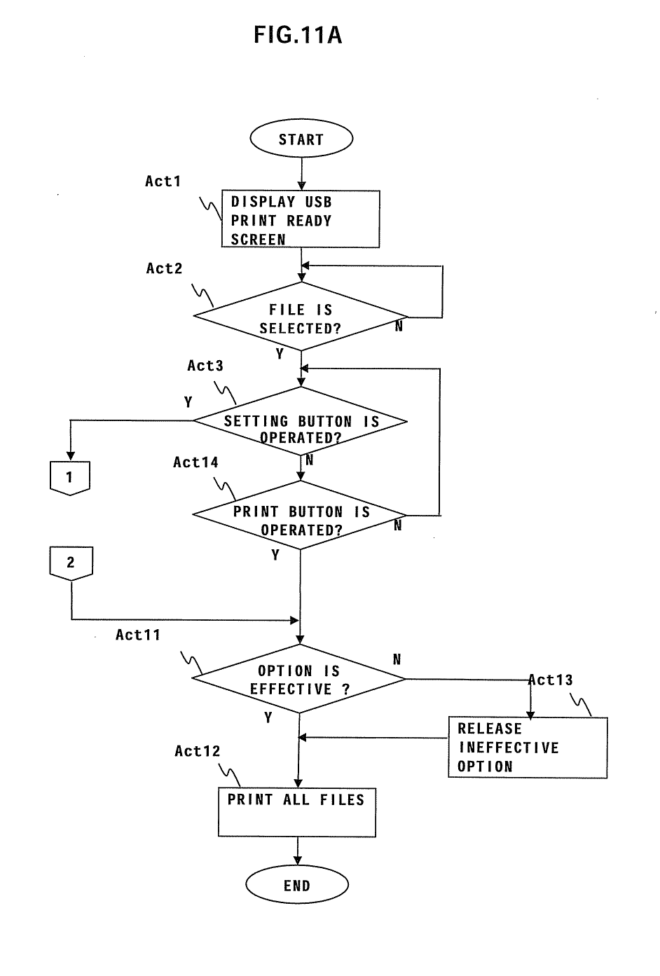

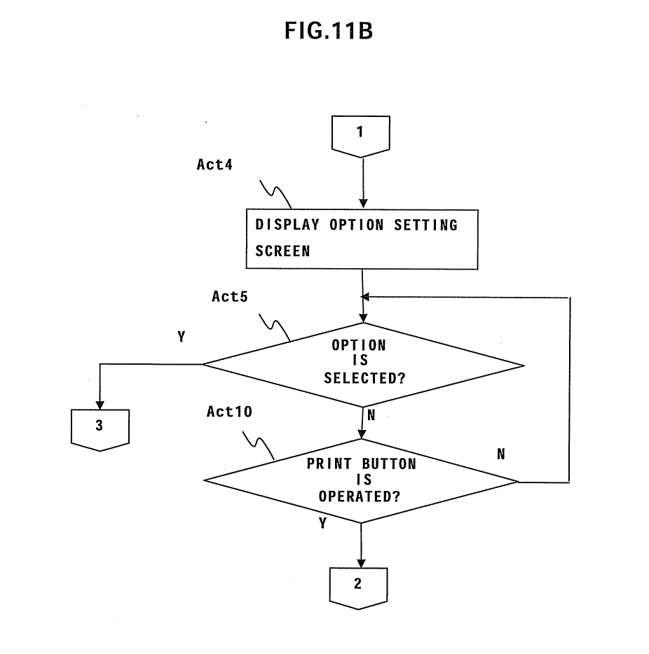

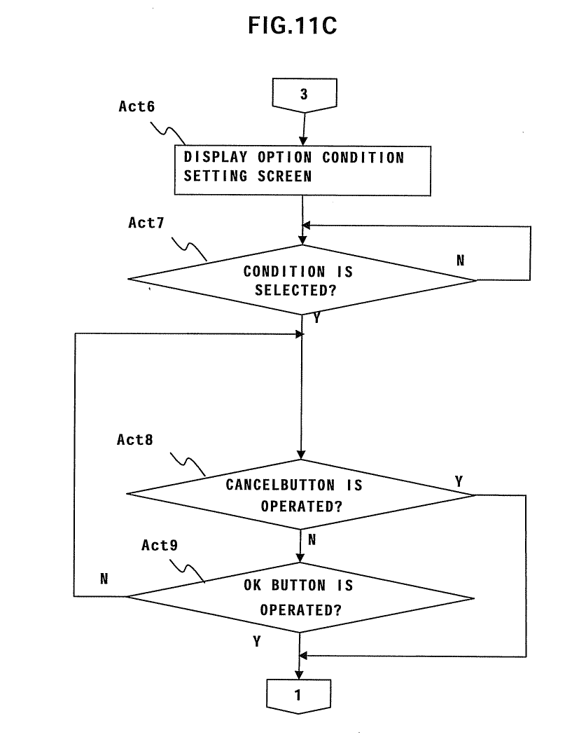

The operation of the functional blocks including the hardware units explained above is explained below. FIGS. 11A to 11C are flowcharts for explaining an operation example (an example 1) of the image forming apparatus 100. The flowchart starts from a state in which the detecting section 1 detects that the USB memory 60 is connected to the USB I/F 15, the print mode is selected on the initial screen shown in FIG. 4, and the USB print is selected as the job type on the ready screen shown in FIG. 5.

First, in Act 1, the UI section 5 displays, on the touch panel of the control panel 105, the ready display screen (FIG. 5) including the list of the file name of the data files stored in the USB memory 60.

After the display of the ready display screen (FIG. 5), in Act 2, the UI section 5 waits for a document file in the list to be selected by the user.

If the UI section 5 receives selection of a document file by the user (Yes in Act 2), in Act 3 and Act 14, the UI section 5 waits for the setting button 53 or the print button 54 to be operated by the user.

If the setting button 53 is not operated (No in Act 3) and if the UI section 5 receives the operation of the print button 54 (Yes in Act 14), in Act 11, the determining section 2 performs determination of a currently-set printing option. Operation contents in Act 11 and subsequent acts are explained later.

If the UI section 5 receives the operation of the setting button 53 by the user (Yes in Act 3), in Act 4, the UI section 5 displays the printing option setting screen (FIG. 6) on the touch panel of the control panel 105.

After the display of the printing option setting screen, (FIG. 6), in Act 5 and Act 10, the UI section 5 waits for any one of the printing option setting icons 61, 62, 63, and 64 to be set by the user or the print button 66 to be operated by the user.

If no printing option setting icon is set (No in Act 5) and if the UI section 5 receives the operation of the print button 66, in Act 11, the determining section 2 performs determination of a currently-set printing option. Actions in Act 11 and subsequent acts are explained later.

If the UI section 5 receives the setting of the printing option by the user (Yes in Act 5), in Act 6, the UI section 5 displays a printing option condition setting screen (the condition setting screen shown in any one of FIGS. 7, 8, 9, and 10) on the touch panel of the control panel 105. For example, if the one-sided or two-sided printing setting icon 63 is set by the user in Act 5, in Act 6, the one-sided printing icon 91, the book printing icon 92, and the tablet printing icon 93 are displayed on the one-sided or two-sided printing condition setting screen (FIG. 9).

After the display of the printing option condition setting screen (FIG. 7, 8, 9, or 10), in Act 7, the UI section 5 waits for a condition setting icon to be selected by the user.

If the UI section 5 receives the selection of a condition setting icon by the user (Yes in Act 7), in Act 8 and Act 9, the UI section 5 waits for the cancel button 72, 84, 94, or 203 or the OK button 73, 85, 95, or 204 to be operated by the user.

If the UI section 5 receives the operation of the cancel button 72, 84, 94, or 203 by the user (Yes in Act 8) or if the UI section 5 receives the operation of the OK button 73, 85, 95, or 204 by the user (Yes in Act 9), in Act 4, the UI section 5 displays the printing option setting screen (FIG. 6) again on the touch panel of the control panel 105. If the cancel button 72, 84, 94, or 203 is operated by the user, the UI section 5 cancels the printing option condition set in Act 7. If the OK button 73, 85, 95, or 204 is operated by the user, the UI section 5 decides the printing option condition set in Act 7.

After the display of the printing option setting screen, in Act 5 and Act 10, UI section 5 waits again for any one of the printing option setting icons 61, 62, 63, and 64 to be set by the user or the print button 66 to be operated by the user.

If the UI section 5 receives the setting of the printing option by the user (Yes in Act 5), the UI section 5 repeats the operation explained above. If the UI section 5 does not receive the setting of the printing option by the user (No in Act 5) and if the UI section 5 receives the operation of the print button 66 (Yes in Act 10), in Act 11, the determining section 2 performs determination of the printing option.

The determining section 2 determines, from attribute information of a selected data file, whether the set printing option is effective or ineffective.

For example, the determining section 2 checks the number of pages as the attribute information of the selected data file. If the number of pages is one, the determining section 2 determines that the two-sided printing and the finishing stapling are ineffective as the printing options. Besides, the determining section 2 determines color information as the attribute information of the selected data file. If the color information is black and white, the determining section 2 determines that the color printing is ineffective as the printing option.

If there are plural selected data files and there are plural set printing options, the determining section 2 determines whether the printing options are effective or ineffective with respect to the data files.

If all the printing options are effective with respect to all the data files as a result of the determination (Yes in Act 11), in Act 12, the processing executing section 4 performs printing for all the data files according to the printing options. If the printing option is ineffective as a result of the determination (No in Act 11), in Act 13, the processing executing section 4 releases the ineffective printing option and sets, for example, a default printing option with respect to only the data file for which the ineffective printing option is set. In Act 12, the processing executing section 4 performs printing for all the data files according to the printing options.

Therefore, according to the embodiment, it is possible to simultaneously select plural data files stored in the external storage (the USB memory 60) and set the printing options in common to all the selected data files to perform printing.

The processing explained with reference to FIGS. 11A, 11B, and 11C can be realized by causing the CPU 11 to execute the computer programs stored in the FROM 13. A storage destination of the computer programs is not limited to the FROM. For example, a HDD (Hard Disk Drive), a RAM (Random Access Memory), a ROM (Read Only Memory), a DRAM (Dynamic Random Access Memory), an SRAM (Static Random Access Memory), and a VRAM (Video RAM) can be used.

In the example explained above, the computer programs for causing the CPU 11 to execute the processing in this embodiment are recorded in the storage area provided in the image forming apparatus 100. However, the computer programs may be downloaded to the image forming apparatus 100 from a network. The computer programs stored in a computer-readable recording medium may be installed in the image forming apparatus 100. The recording medium only has to be a recording medium that can store the computer programs and can be read by a computer. Examples of the recording medium include an internal storage device internally mounted in a computer such as a ROM or a RAM, a portable storage medium such as a CD-ROM, a flexible disk, a DVD disk, a magneto-optical disk, or an IC card, a database that stores a computer program, other computers and databases of the computers, and a transmission medium on a line. Functions obtained by installation or download in advance maybe realized in cooperation with an OS (operating system) in an apparatus. It is also possible to cause an ASIC to execute, in terms of a circuit, at least a part of processing realized by causing a CPU (Central Processing Unit) or an MPU (Micro Processing Unit) to execute the computer programs.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus to which an external storage can be connected and that prints a data file stored in the external storage, the image forming apparatus comprising:
a display section configured to display, if the external storage is connected, as a list, plural kinds of file information for respectively specifying plural data files stored in the external storage;
a file selecting section configured to designate the file information in order to select, out of the data files, a data file to be printed; and
an option selecting section configured to select a printing option common to the plural date files selected by being designated by the file selecting section.

2. The apparatus according to claim 1, further comprising a determining section configured to determine, on the basis of attribute information of the data files, whether the printing option designated by the option selecting section is an effective printing option.

3. The apparatus according to claim 2, further comprising a processing executing section configured to release the selection of the printing option determined as ineffective by the determining section.

4. The apparatus according to claim 3, wherein the determining section determines whether the printing option selected by the option selecting section is a printing option effective with respect to all selected data files.

5. The apparatus according to claim 4, wherein the processing executing section releases the selection of the printing option determined as ineffective by the determining section with respect to only the data file for which the printing option is determined as ineffective by the determining section.

6. The apparatus according to claim 5, wherein, if plural printing options are selected by the option selecting section, the determining section determines, for each of the data files, whether all the printing options are effective printing options with respect to the attribute information of the data file.

7. The apparatus according to claim 6, wherein the processing executing section releases the selection of only the printing option determined as ineffective by the determining section with respect to only the data file for which the printing option is determined as ineffective by the determining section.

8. The apparatus according to claim 7, wherein
if two-sided printing for applying printing to both sides of a sheet is designated as the printing option, the determining section checks numbers of pages of the data files as attribute information and determines that the two-sided printing is the ineffective printing option with respect to the data file, the number of pages of which is one, and
the processing executing section releases the selection of the two-sided printing as the printing option with respect to the data file, the number of pages of which is one.

9. The apparatus according to claim 8, wherein
if stapling of printed sheets with staples is designated as the printing option, the determining section checks number of pages of the data files as attribute information and determines that the stapling is the ineffective printing option with respect to the data file, the number of pages of which is one, and
the processing executing section releases the selection of the stapling as the printing option with respect to the data file, the number of pages of which is one.

10. The apparatus according to claim 1, wherein the file information includes file names for specifying the data files.

11. The apparatus according to claim 1, wherein the display section displays a first screen including the list of the plural kinds of file information and a second screen for selecting the printing option with the option selecting section.

12. The apparatus according to claim 11, wherein
the second screen includes icons corresponding to plural printing options, and
the display section displays, according to selection of any one of the option icons, a third screen for setting a condition for the printing option corresponding to the selected icon.

13. The apparatus according to claim 12, wherein the third screen includes icons corresponding to plural conditions in the selected printing option.

14. The apparatus according to claim 13, wherein
the third screen includes a decision button for deciding selection of any one of the condition icons, and
the display section displays the second screen if the decision button is pressed.

15. A processing control method comprising:
displaying, if an external storage is connected to an image forming apparatus, as a list, file information for specifying data files stored in the external storage;
designating the file information in order to select, out of the data files, a data file to be printed; and
selecting a printing option common to all the date files selected by being designated.

16. The method according to claim 15, further comprising determining, on the basis of attribute information of the data files, whether the selected printing option is an effective printing option.

17. The method according to claim 16, further comprising releasing the selection of the printing option determined as ineffective by the determining.

18. The method according to claim 17, wherein the determining includes determining whether the selected printing option is a printing option effective with respect to all selected data files.

19. The method according to claim 15, further comprising displaying a first screen including the list of the plural kinds of file information and a second screen for selecting the printing option.

20. The method according to claim 19, wherein
the second screen includes icons corresponding to plural printing options, and
the method further comprises displaying, according to selection of any one of the option icons, a third screen for setting a condition for the printing option corresponding to the selected icon.
